(19) United States
(12) Patent Application Publication
(10) Pub. No.: US 2025/0236303 A1
(43) Pub. Date: Jul. 24, 2025

(54) METHOD AND DEVICE FOR CONTROLLING A SYSTEM WITH FUNCTIONAL SAFETY REQUIREMENTS

(71) Applicant: Robert Bosch GmbH, Stuttgart (DE)

(72) Inventors: Armin Verhagen, Schwieberdingen (DE); Laszlo Boros, Ludwigsburg (DE); Simon Peter, Weil Der Stadt (DE); Volker Mehl, Bruchsal-Untergrombach (DE); Xi Nowak, Bisingen (DE); Simon Schrade, Baindt (DE)

(21) Appl. No.: 18/984,074

(22) Filed: Dec. 17, 2024

(30) Foreign Application Priority Data
Jan. 18, 2024 (DE) 10 2024 200 438.3

(51) Int. Cl. B60W 50/00

(52) U.S. Cl. CPC B60W 50/0098

(57) ABSTRACT

A system, a device, and a method for controlling the system with functional safety requirements. The method includes determining a control for the system according to a first control method, which satisfies first requirements for the functional safety of the system; determining a control for the system according to a second control method; determining a difference between the control for the system according to the first control method and the control for the system according to the second control method; and outputting a signal for controlling the system according to the first requirements for the functional safety of the system on the basis of the determined difference.

### CROSS REFERENCE

The present application claims the benefit under 35 U.S.C. § 119 of German Patent Application No. DE 10 2024 200 438.3 filed on Jan. 18, 2024, which is expressly incorporated herein by reference in its entirety.

### FIELD

The present invention relates to a method and a device for controlling a system with functional safety requirements, in particular for systems in the automotive, aviation and/or aerospace industries.

### BACKGROUND INFORMATION

The manufacture, modification and/or improvement of components of a system on which safety requirements are imposed requires that the system and its components be developed to meet the functional safety requirements of the components and of the system.

In the exemplary case of use of an indirect electromechanical brake device, for example instead of a direct mechanical brake device, in a vehicle as shown in FIG. 2, it may be necessary to satisfy the requirements for controllability of the vehicle when driving through curves, for example. Yawing of the vehicle can, for example, be prevented so that no one is harmed by the vehicle.

In the exemplary case of use of an indirect, automatic steering system of an aircraft, it may be necessary to satisfy the requirements for a possibility of a pilot correcting the automatic steering system so that the aircraft can be controlled directly if the indirect, automatic steering system functions incorrectly and must be corrected in order to prevent harm.

Electromechanical devices are generally characterized in that an actuator, such as an electric motor, is actuated indirectly via an electronic control system in order to control a system such that the requirements for the functional safety of the system are met. The use of, for example, sensor data and/or complex algorithms for controlling the actuators can make it difficult to implement the requirements for the functional safety of the system, both from a technical point of view due to the more complex implementation and financially due to increased costs for the development from the component level to the system level.

Conventional devices for controlling a system use redundant control methods and/or devices for controlling the system and a unit for monitoring an active control method and/or an active device for controlling the system. The monitoring unit is configured to switch from the active control method and/or the active device to the redundant control method and/or to the redundant device in response to a determination that one or more monitoring criteria are met or not met. Both the active control method and/or the active device and the redundant control method and/or the redundant device must therefore meet the requirements for the functional safety of the system.

German Patent Application No. DE 10 2021 121 828 A1 describes an electromechanical brake device for a vehicle, comprising at least one friction brake device and an electromechanical actuator for actuating the friction brake device, wherein the electromechanical brake device comprises a pneumatically releasable spring-loaded actuator. The spring-loaded actuator can be arranged and/or configured to exert force directly on at least one friction brake element.

### SUMMARY

The present invention provides a method and a device for controlling a system with functional safety requirements.

Preferred example embodiments of the present invention are disclosed herein.

The method and device according to the present invention for controlling a system make it possible to implement complex control systems for the system in a simplified manner while always meeting the requirements for the functional safety of the system.

According to a first aspect, the present invention relates to a method for controlling a system with functional safety requirements. According to an example embodiment of the present invention, the method includes determining a control for the system according to a first control method, which satisfies first requirements for the functional safety of the system; determining a control for the system according to a second control method; determining a difference between the control for the system according to the first control method and the control for the system according to the second control method; and outputting a signal for controlling the system according to the first requirements for the functional safety of the system on the basis of the determined difference.

According to a development of the present invention, the method furthermore comprises determining whether the difference is within a first tolerance range around a control for the system according to the first control method; and, in response to a determination that the difference is within the first tolerance range, outputting the signal for controlling the system, wherein the signal follows the control for the system according to the second control method.

According to a development of the present invention, the method furthermore comprises, in response to a determination that the difference is outside the first tolerance range, outputting the signal for controlling the system, wherein the signal follows the control for the system according to the first control method.

According to a development of the present invention, the method furthermore comprises, in response to a determination that the difference is outside the first tolerance range, determining whether the difference is within a second tolerance range around the control for the system according to the first control method; and outputting the signal for controlling the system, wherein the signal follows a control for the system according to a third control method, which satisfies second requirements for the functional safety of the system.

According to a development of the present invention, determining the control for the system according to the first control method and determining the control for the system according to the second control method take place simultaneously and/or continuously and/or in parallel and/or alternately sequentially.

According to a development of the present invention, the first control method is selected depending on an operating mode of the system and/or depending on a selection by a user of the system.

According to a development of the present invention, the first control method is selected from a plurality of first control methods, wherein each of the plurality of first control methods satisfies the first functional safety requirements.

According to a second aspect, the present invention relates to a device for controlling a system with functional safety requirements. According to an example embodiment of the present invention, the device comprises one or more processors; and a nonvolatile, computer-readable storage medium comprising instructions stored thereon that, when executed by the one or more processors, cause the device to control the system according to the method of the present invention described above.

According to a development of the present invention, the device furthermore comprises at least one electromechanical control device, wherein the electromechanical control device does not permit direct mechanical control.

According to a third aspect, the present invention relates to a system, wherein the system comprises at least one of the device according to the present invention.

### BRIEF DESCRIPTION OF THE DRAWINGS

FIG. 1 shows a schematic illustration of an exemplary embodiment of a device for controlling a system with high functional safety requirements, according to the present invention.

FIG. 2 shows a schematic illustration of an exemplary embodiment of an electromechanical brake device, which is to be controlled by an exemplary embodiment of the device for controlling a system according to FIG. 1.

FIG. 3 shows a schematic illustration of a vehicle with the exemplary embodiments of the electromechanical brake device according to FIG. 2, which are controlled by an exemplary embodiment of the device for controlling the system according to FIG. 1.

FIG. 4 shows a schematic illustration of a control signal for controlling a system according to a conventional method (top) and according to an exemplary method according to the present invention (bottom).

FIG. 5 shows a schematic illustration of a method for controlling a system with high functional safety requirements.

### DETAILED DESCRIPTION OF EXAMPLE EMBODIMENTS

In all figures, identical or functionally identical elements and devices are provided with the same reference signs. The numbering of method steps is for the sake of clarity and is generally not intended to imply a specific chronological order. It is in particular also possible to carry out multiple method steps simultaneously.

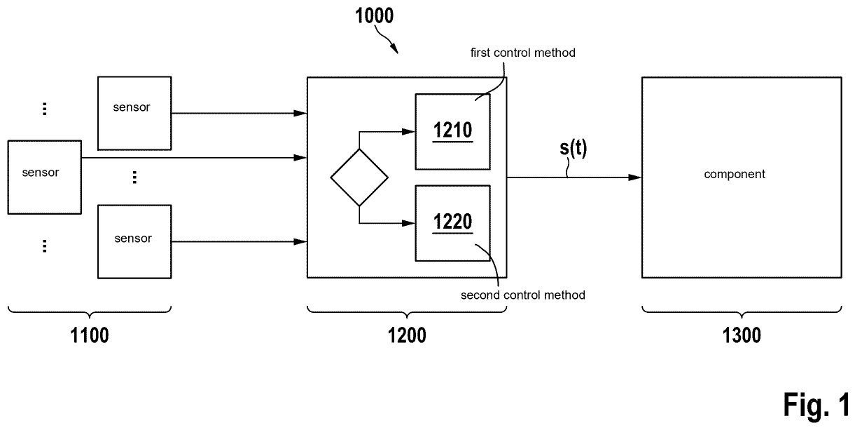

FIG. 1 shows a schematic illustration of an exemplary embodiment of a device 1200 for controlling a system 1000 with high functional safety requirements. The system 1000, for example a vehicle or an aircraft, comprises a component 1300, which is relevant to the functional safety of the system 1000. The system 1000 comprises the device 1100 and can furthermore comprise a sensor system 1100.

The sensor system 1100 can comprise a sensor or a plurality of sensors 1100. A sensor may, for example, be a force sensor, a position sensor, a current sensor, a sensor providing data related to a rotational speed of one or more wheels of the system 1000, an acceleration sensor, an air speed sensor, an angle-of-attack sensor, attitude sensors, a gyroscope, a sensor for receiving data from a radio network and/or from a satellite, and/or any other sensor providing data relevant to the functional safety of the system 1000. The sensor system 1100 may comprise any combination of two or more of the sensors mentioned above.

The device 1200 for controlling the system 1000 is configured to control the component 1300 according to a first control method 1210. The first control method 1210, the so-called direct law, meets the requirements for the functional safety of the system 1000. The first control method 1210 may, for example, meet the requirements according to ASIL D, i.e., the requirement of Automotive Safety Integrity Level D. ASIL D refers to the highest classification of initial hazard (injury risk) defined in the ISO 26262 standard and to the most stringent level of safety measures to be applied according to this standard in order to avoid residual risk. Alternatively, the direct law may be developed according to DAL A, i.e., according to the requirement of Design Assurance Level A, in aviation if the system 1000 is classified as safety-critical according to the catastrophic hazard class.

The first control method 1210 can receive data from a minimum required number of sensors required to control the system 1000 such that the functional safety requirements are met, for example ASIL D. The device 1200 may also be configured to control the system 1000 such that the system 1000 is subject to lower functional safety requirements, ASIL C, ASIL B, ASIL A, or the quality management (QM) requirements. This may, for example, be achieved by the first control method 1210 a priori preventing operating states of the system 1000 that lead to the system 1000 being subjected to higher functional safety requirements, for example yawing of a vehicle when driving through curves at high speed.

The first control method 1210 may, for example, be based on data from a single sensor, from a maximum of two sensors or a maximum of three sensors. Costs for implementing and/or demonstrating that the functional safety requirements are met can consequently be reduced in comparison to more complex control methods.

The device 1200 for controlling the system 1000 is furthermore configured to control the component 1300 according to a second control method 1220. The second control method 1220, the so-called normal law, need not necessarily meet the requirements for the functional safety of the system 1000. The second control method 1220 may meet none or a portion of the requirements. For example, the second control method 1220 may meet the requirements according to QM, ASIL A, ASIL B, or ASIL C.

The second control method 1220 can receive data from any number of sensors and/or models in order to control the system 1000. The second control method 1220 may, for example, be based on data from at least one sensor, from at least two sensors or at least three sensors. The number of sensors used to control the system 1000 according to the second control method 1220 can in particular be greater than the number of sensors used to control the system 1000 according to the first control method 1210.

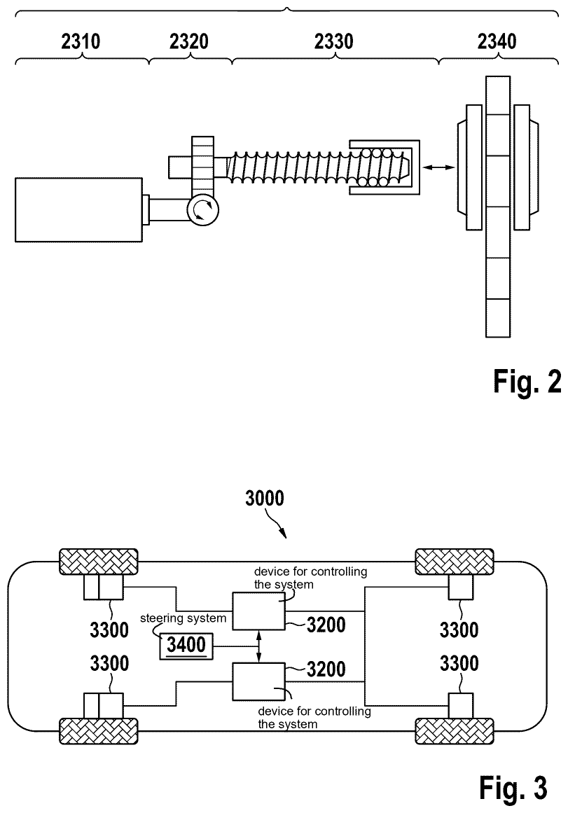

The second control method 1220 can in particular be more complex than the first control method 1210. For example, the second control method 1220 can take into account wear of components, such as an electric motor, a spindle, etc., cf. FIG. 2, when controlling the system 1000, for example through data from sensors or based on one or more models. In particular, the second control method 1220 can take into account external disturbing factors, such as wind forces. In particular, the second control method 1220 can use artificial intelligence to improve the control method 1220 in operation, for example to adapt it continuously to a user of the system 1000 or to the system 1000 itself.

FIG. 2 shows a schematic illustration of an exemplary embodiment of a component of a system, an electromechanical brake device 2300, which can be controlled, for example by a device for controlling a system. Shown in the electromechanical brake device 2300 are a brake disk with brake pads 2340, a spindle 2330, a transmission 2320, and an electric motor 2310. The electromechanical brake device 2300 is designed to actuate the brake device indirectly and does not allow purely mechanical actuation of the brake, for example hydraulic actuation.

Figure [sic]¹ shows a schematic illustration of a vehicle 3000 with exemplary embodiments of electromechanical brake devices 3300, which are controlled by exemplary embodiments of the device 3200 for controlling the system 3000. 1 [Translator's note: Sentence seems to be missing the number “3” as in “FIG. 3”.]

For example, the vehicle 3000 comprises four electromechanical brake devices 3300. Each electromechanical brake device 3300 can be coupled to one or more devices 3200 for controlling the system 3000 in order to control the system 3000. The system 3000 can be steered by a steering system 3400. The steering system 3400 can be coupled, directly or indirectly, to one or more devices 3200 for controlling the system 3000.

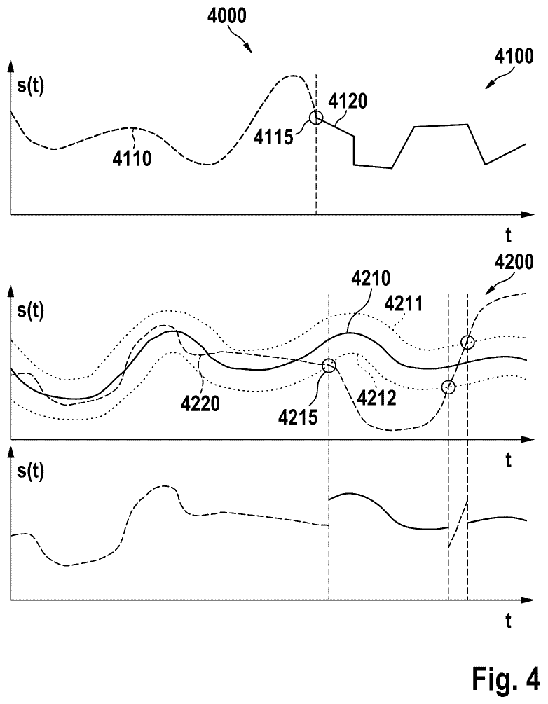

FIG. 4 shows a schematic illustration of a control signal s(t) for controlling a system according to a conventional method 4100 (top) and according to an exemplary method 4200 according to the present invention (bottom).

According to the conventional method 4100, a control signal s(t) for controlling a system or component is controlled according to an active control method 4110, wherein the active control method 4110 and/or the system and/or components thereof are monitored. The active control method 4110 meets the requirements for the functional safety of the system, for example ASIL D. In response to a determination that one or more monitoring criteria are met or not met, point 4115 in FIG. 4, switching takes place in the conventional method 4100 from the active control method 4110 to a redundant control method 4120 and the control signal s(t) is output on the basis of the redundant control method 4120. In this case, the redundant control method 4120 can represent worsening, i.e., a degradation, of the system behavior.

The determination that one or more monitoring criteria are met or not met can, for example, be carried out on the basis of sensor data and, for example, by using a switch for switching between devices in which the active control method 4110 or the redundant control method 4120 are implemented.

According to the exemplary method 4200 according to the present invention, a control signal s(t) for controlling a system or a component is always output as a result of at least two possible control methods, which are available concurrently for controlling the system. The requirements for the functional safety of the system and/or of components thereof are not or not necessarily met by all control methods of the at least two possible control methods. However, at least one control method of the at least two possible control methods meets the requirements for the functional safety of the system and/or of components thereof.

As shown in FIG. 4 without limiting generality (oBdA), the method according to the present invention can output a control signal s(t) that follows a control according to a second control method 4220, as long as the control signal s(t) is within a tolerance range around a control signal according to a first control method 4210. The first control method 4210 meets the requirements for the functional safety of the system and/or of components thereof in the tolerance range so that the second control method 4220 does not necessarily have to meet the functional safety requirements if the control signal s(t) outputted to the system is within the tolerance range around the control signal according to the first control method 4210. In other words, the requirements for the functional safety of the system are met while the requirements for implementing the second control method 4220 are relaxed.

If the control signal s(t) exits the tolerance range, for example at reference sign 4215, the control signal s(t) essentially follows the control according to the first control method 4210, with smoothing of the signal in the transition range if necessary. When the control according to the second control method 4220 occurs again, the output control signal s(t) can again follow the control according to the second control method 4220.

The control can furthermore be carried out differently, for example on the basis of driving situations, for example on the basis of control methods for driving straight forward or driving through curves.

If a change from one control method to another control method takes place, for example from the first control method 4210 to the second control method 4220 and/or vice versa, the change can be registered. The registration may, for example, be carried out in order to read out the event, for example in a workshop, and/or to transmit associated data wirelessly and/or by wire directly to a manufacturer of the device and/or of a component.

A plurality of tolerance ranges can also be used to output the signal s(t), for example depending on the driving situation and/or depending on available control methods that meet the same or different requirements for the functional safety of the system.

The signal s(t) can be output such that short-term exceeding of a tolerance range is permitted, for example for 1, 2, 5, or 10 seconds. Alternatively, short-term exceeding of a first tolerance range can be permitted, while exceeding of a second tolerance range is not permitted, in order to meet the requirements for the functional safety of the system. The signal s(t) can in particular be output such that the output signal is always within a tolerance range of the control method that meets the highest requirements for the functional safety of the system. If multiple control methods meet the highest requirements, outputting the signal s(t) can follow the control according to the control method that is selected, for example by a user.

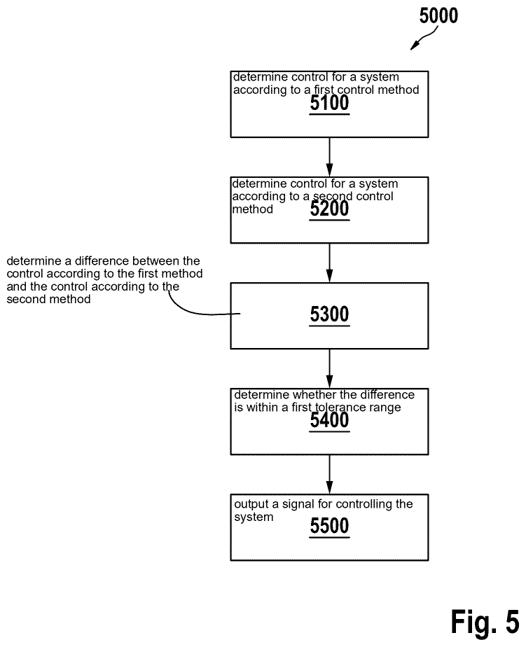

FIG. 5 shows a schematic illustration of a method 5000 for controlling a system with high functional safety requirements.

The method comprises determining 5100 a control for a system according to a first control method, which satisfies first requirements for the functional safety of the system; determining 5200 a control for a system according to a second control method; determining 5300 a difference between the control for the system according to the first control method and the control for the system according to the second control method; determining 5400 whether the difference is within a first tolerance range; outputting 5500 a signal for controlling the system according to the requirements for the functional safety of the system on the basis of the determined difference.

It should be noted that different standards may be relevant in different industries, countries, and areas, which standards are referenced here in a general manner, without explicitly identifying any relevant standard. The principles of the devices and methods disclosed here can be implemented in conjunction with any of these standards.

What is claimed is:

1. A method for controlling a system with functional safety requirements, the method comprising the following steps:
determining a control for the system according to a first control method, which satisfies first requirements for the functional safety of the system;
determining a control for the system according to a second control method;
determining a difference between the control for the system according to the first control method and the control for the system according to the second control method; and
outputting a signal for controlling the system according to the first requirements for the functional safety of the system based on the determined difference.

2. The method according to claim 1, the method further comprising:
determining whether the difference is within a first tolerance range around a control for the system according to the first control method; and
in response to a determination that the difference is within the first tolerance range, performing the outputting of the signal for controlling the system, wherein the signal follows the control for the system according to the second control method.

3. The method according to claim 2, further comprising:
in response to a determination that the difference is outside the first tolerance range, performing the outputting of the signal for controlling the system, wherein the signal follows the control for the system according to the first control method.

4. The method according to claim 2, further comprising:
in response to a determination that the difference is outside the first tolerance range, determining whether the difference is within a second tolerance range around the control for the system according to the first control method; and
performing the outputting of the signal for controlling the system, wherein the signal follows a control for the system according to a third control method, which satisfies second requirements for the functional safety of the system.

5. The method according to claim 1, wherein the determining of the control for the system according to the first control method and the determining of the control for the system according to the second control method take place simultaneously and/or continuously and/or in parallel and/or sequentially.

6. The method according to claim 1, wherein the first control method is selected depending on an operating mode of the system and/or depending on a selection by a user of the system.

7. The method according to claim 1, wherein the first control method is selected from a plurality of first control methods, wherein each of the plurality of first control methods satisfies the first functional safety requirements.

8. A device configured to control a system with functional safety requirements, wherein the device comprises:
one or more processors; and
a nonvolatile computer-readable storage medium on which are stored instructions stored thereon for controlling a system with functional safety requirements, the instructions, when executed by the one or more processors, cause the one or more processors to perform the following steps:
determining a control for the system according to a first control method, which satisfies first requirements for the functional safety of the system,
determining a control for the system according to a second control method,
determining a difference between the control for the system according to the first control method and the control for the system according to the second control method, and
outputting a signal for controlling the system according to the first requirements for the functional safety of the system based on the determined difference.

9. The device according to claim 8, wherein the device further comprises:
at least one electromechanical control device, wherein the electromechanical control device does not permit direct mechanical control.

10. A system, comprising:
at least one device configured to control a system with functional safety requirements, wherein the at least one device comprises:
one or more processors; and
a nonvolatile computer-readable storage medium on which are stored instructions stored thereon for controlling a system with functional safety requirements, the instructions, when executed by the one or more processors, cause the one or more processors to perform the following steps:
determining a control for the system according to a first control method, which satisfies first requirements for the functional safety of the system,
determining a control for the system according to a second control method,
determining a difference between the control for the system according to the first control method and the control for the system according to the second control method, and
outputting a signal for controlling the system according to the first requirements for the functional safety of the system based on the determined difference.
